(19) United States
(12) Patent Application Publication
(10) Pub. No.: US 2008/0240224 A1
(43) Pub. Date: Oct. 2, 2008

(54) STRUCTURE FOR ONE-SAMPLE-PER-BIT DECISION FEEDBACK EQUALIZER (DFE) CLOCK AND DATA RECOVERY

(76) Inventors: JUAN A. CARBALLO, San Francisco, CA (US); Hayden C. Cranford, Cary, NC (US); Gareth J. Nicholls, Brockenhurst (GB); Vernon R. Norman, Cary, NC (US); Martin L. Schmatz, Rueschlikon (CH)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 12/138,214

(22) Filed: Jun. 12, 2008

Related U.S. Application Data
(63) Continuation-in-part of application No. 11/405,997, filed on Apr. 18, 2006.

(51) Int. Cl. H04L 27/01

(52) U.S. Cl. 375/233

(57) ABSTRACT

A design structure embodied in a machine readable storage medium for designing, manufacturing, and/or testing a design of a decision feedback equalizer (DFE) Clock-And-Data Recovery (CDR) architecture that utilizes/produces one sample-per-bit in the receiver and reduces bit-error-rate (BER) is provided. The design generally includes a receiver circuit. The receiver circuit generally includes a decision feedback equalizer (DFE) that produces one sample per bit, and means for automatically self-adjusting the DFE to enable an eye centering process by which peak energy is maintained within the receiver circuit when phase error is a minimum.

### CROSS-REFERENCE TO RELATED APPLICATION

This application is a continuation-in-part of co-pending U. S. patent application Ser. No. 11/405,997, filed Apr. 18, 2006, which is herein incorporated by reference.

### BACKGROUND OF THE INVENTION

1. Field of the Invention

The present invention relates generally to design structures, and more specifically, design structures for electric circuits and in particular to data receivers. Still more particularly, the present invention relates to equalization-based data receivers.

2. Description of the Related Art

Most modern data transmission relies on high-speed input/output (I/O) electrical data transmission channels linking a data transmitter (or transceiver) and a data receiver (i.e., the receiving circuit of a transceiver). Typically, this channel has a nonlinear frequency/phase response due to non-ideal conditions, which affect (e.g., distorts, attenuates, etc.) the transmitted data propagating through the channel. These non-ideal conditions within the channel causes inter-symbol-interference (ISI), leading to timing uncertainties at the receiver and an increase in the bit error rate (BER). Those skilled in the art are familiar with electrical data transmission channels and the occurrence of ISI and other conditions, such as increased BERs.

To compensate for the channel induced ISI, equalization techniques are utilized. These equalization techniques typically consist of any combination of digital and/or analog, linear or non-linear filters. Among these different types of filters are finite impulse response (FIR) filters and infinite impulse response (IIR) filters. Other components utilized to assist in equalization include amplification stages in the signal driver and/or preamplifiers with programmable or fix pole/zero distribution. Nonlinear IIR filters (also known as decision feedback equalizers or DFE) exhibit a very high equalization capability. Because of the widespread use of at least one of these equalizers at the receiver end of the date transmission channel, the receiver may generally be referred to as an equalization-based receiver.

FIG. 1 illustrates a prior art DFE circuit, with circuit components represented by blocks. As shown, DFE comprises an input amplifier/buffer 103 which receives input data signal (input voltage) 101 and forwards the amplified input voltage to voltage summing node 105. Weighted voltages determined by the values of previously detected bits and their respective filter/feedback coefficients (k0 . . . km) 111a-m are also summed at this node 105. Voltage summing node 105 sums the voltage output (amplified input data signal) from the amplifier/buffer 103 with voltages across parallel branches of filter/feedback coefficients 111a-m. Filter/feedback coefficients (k0 . . . kn) 111a-m are utilized to provide a multiplication factor for associated voltages of previously detected bits, and each coefficient is a programmable value.

The summed voltage is provided across edge latch 109 and a delay path comprising sample and delay latch (sampling latch) 107 series connected to a sequence of delay elements (z⁻¹) 113a-n (where n is illustrated as being m−1). Each of sampling latch 107 and delay elements 113a-n receive an input of the data clock 108 to enable synchronized operation of the DFE circuit. Edge latch 109 receives a clock input from edge clock 110 and produces edge value output 115. A second output, data output 117 is tapped off of the node between sampling latch 107 and the first of the sequence of series-connected delay elements (i.e., delay 113a). Both output, edge value output 115 and data output 117 are sent to data FIFO (not shown), phase detector (not shown) and further to the clock and data recovery (CDR) loop (also not specifically shown).

One aspect of the design of receivers on I/O links is that the sampling clock phase in the receiver has to be adjusted to sample the incoming bits at or close to the optimum phase position, e.g. where the signal energy of the bit is at its maximum. This sampling is an important/key component to achieve minimum bit error rate performance. It is not a coincidence therefore, that one of the key sources of complexity in equalization-based receivers is the number of samples per bit utilized. Reducing this complexity is critical, since it also results in a reduction in power consumption of the receiver and the amount of area allocated to components in transmission channels (or applications) that require receiver equalization. While conventional integration methods have been implemented to attempt to overcome this requirement, there still exists a problem with conventional integration in that a very small value may be obtained if the timing is wrong.

### SUMMARY OF THE INVENTION

Disclosed is a receiver circuit, method and design architecture of a decision feedback equalizer (DFE) Clock-And-Data Recovery (CDR) architecture that utilizes/produces one sample-per-bit in the receiver and reduces bit-error-rate (BER). The method and circuit design combines an integrating receiver with a decision feedback equalizer along with the appropriate (CDR) loop with peak detector (i.e., whereby the phase error is smallest when the peak is maximum) to maintain a single sample per bit requirement. This configuration enables performance of an eye centering algorithm, which maintains the peak energy. The output power (energy) of the latch is maximized to obtain the correct phase by performing integration in front of the data latch in order to provide necessary amplification. The integration collects the energy required to switch the latch and further enables alignment of the phases.

In one embodiment, a design structure embodied in a machine readable storage medium for at least one of designing, manufacturing, and testing a design is provided. The design generally includes a receiver circuit. The receiver circuit generally includes a decision feedback equalizer (DFE) that produces one sample per bit, and means for automatically self-adjusting the DFE to enable an eye centering process by which peak energy is maintained within the receiver circuit when phase error is a minimum.

The incoming voltage is converted to a current and connected to a current summing node. Weighted currents determined by the values of previously detected bits and their respective feedback coefficients are also connected to this node. Then, the sum of all currents is integrated and converted to a voltage. A sampler is then utilized to make a bit decision based on this resulting voltage. After sampling, the integrator is reset before analysis of the next bit. A delay stage is provided and stores a number of previously-detected bits which are connected through the weighted voltage coefficient to feedback current converters. A peak detector is connected to the output of the current integrator, and the value of the peak detector is maximized in the CDR loop by adjusting the sampling clock phase.

Using the above circuit configuration, the coefficients of the DFE feedback paths may be determined by implementing a method that minimizes the variations of the integrated summing currents. The level of system equalization is directly correlated to the inverse size of the variations in the summed and integrated currents. That is, the better the system is equalized, the smaller the variations in the summed and integrated currents will be.

In one alternative embodiment, the integration of the DFE feedback currents may be completed in a second integrator and results of the integration of the data are dependent currents, and the currents from the feedback paths may be applied to the even and odd inputs of a different decision circuit. This embodiment is of special interest when competing single ended data transmission.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram representation of a conventional decision feedback equalizer (DFE) according to the prior art; and

FIG. 2 is a block diagram representation of an enhanced DFE designed according to one embodiment of the invention.

FIG. 3 is a flow diagram of a design process used in semiconductor design, manufacture, and /or test.

### DETAILED DESCRIPTION OF EXEMPLARY EMBODIMENTS

The present invention provides a receiver circuit, method and design architecture of a decision feedback equalizer (DFE) Clock-And-Data Recovery (CDR) architecture that utilizes/produces one sample-per-bit in the receiver and reduces bit-error-rate (BER).

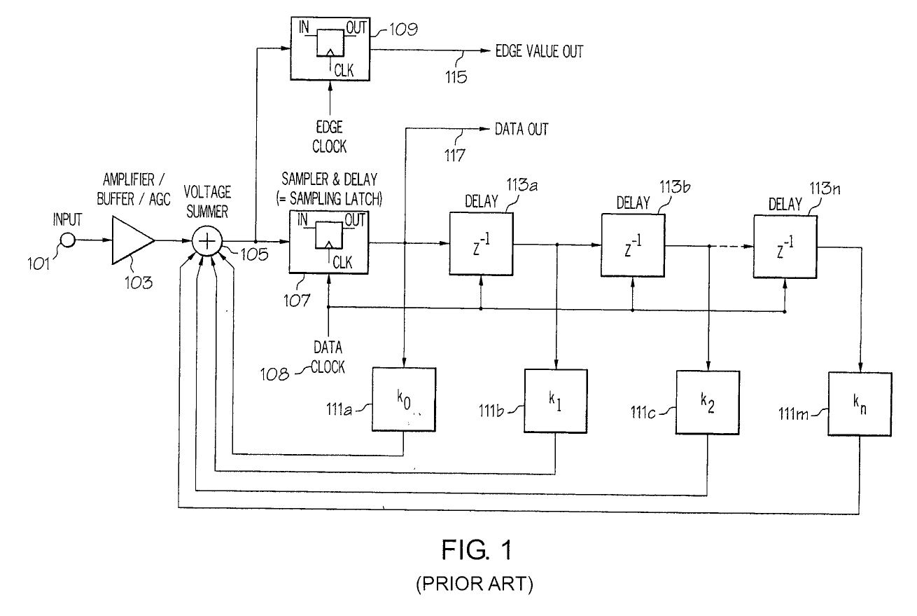

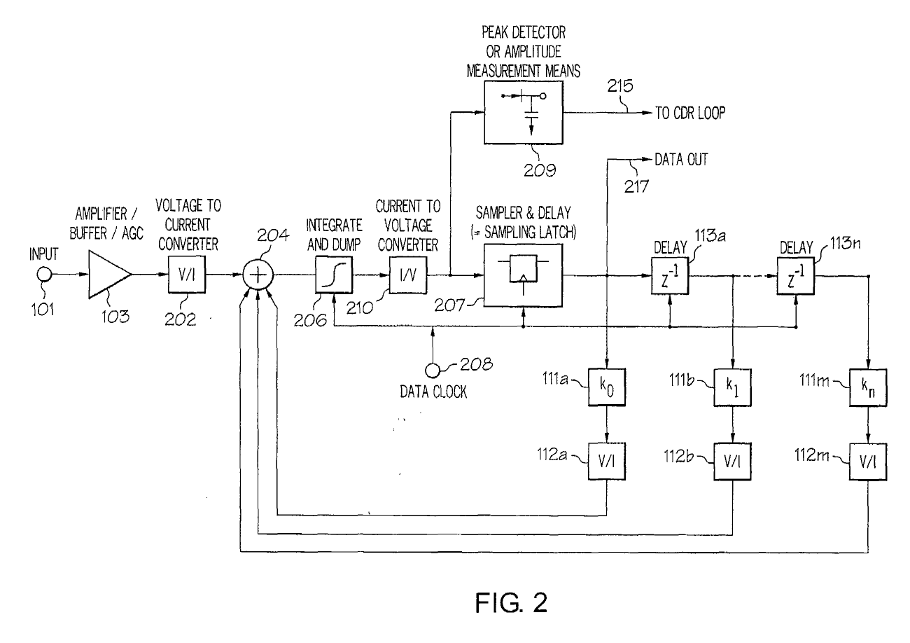

With reference now to the figures, and in particular with reference to FIG. 2, which illustrate a circuit design of the enhanced DFE architecture, according to one embodiment of the invention. Within the descriptions of the figures, (i.e., relative to previously described FIG. 1) similar elements are provided similar names and reference numerals as those of the previous figure. Where the later figure utilizes the element in a different context or with different functionality, the element is provided a different leading numeral representative of the figure number (e.g, 1xx for FIG. 1 and 2xx for FIG. 2). The specific numerals assigned to the elements are provided solely to aid in the description and not meant to imply any limitations (structural or functional) on the invention.

The method and circuit design combines an integrating receiver with a decision feedback equalizer along with the appropriate (CDR) loop with peak detector (i.e., whereby the phase error is smallest when the peak is maximum) to maintain a single sample per bit requirement. This configuration enables performance of an eye centering algorithm, which maintains the peak energy. The output power (energy) of the latch is maximized to obtain the correct phase by performing integration in front of the data latch in order to provide necessary amplification. The integration collects the energy required to switch the latch and further enables alignment of the phases.

The incoming voltage is converted to a current and connected to a current summing node. Weighted currents determined by the values of previously detected bits and their respective feedback coefficients are also connected to this node. Then, the sum of all currents is integrated and converted to a voltage. A sampler is then utilized to make a bit decision based on this resulting voltage. After sampling, the integrator is reset before analysis of the next bit. A delay stage is provided and stores a number of previously-detected bits which are connected through the weighted voltage coefficient to feedback current converters. A peak detector is connected to the output of the current integrator, and the value of the peak detector is maximized in the CDR loop by adjusting the sampling clock phase.

The enhanced DFE of FIG. 2 comprises an input amplifier/buffer 103 which receives the input data signal (input voltage) 101, amplifies the input voltage 101, and forwards the amplified input voltage to voltage-to-current converter 202. At current converter 202, the amplified input voltage is converted to a current, and the converted current signal is forwarded to current summing node 204. Weighted currents determined by the values of previously detected bits and their respective feedback coefficients 211a-m are also tied to current summing node 204. These weighted currents are derived from voltage signals corresponding to the previously detected bits, which are multiplied by respective filter/feedback coefficients 211a-m, and then converted to currents via associated voltage-to-current converters 212a-m. Filter coefficients (k0 . . . kn) 211a-m are utilized to provide a multiplication factor for associated voltages measured after the sampling latch 207 and each subsequent delay element 113a-n. Each feedback coefficient is a programmable value.

Thus, current summing node 204 sums the converted input current received from the voltage-to-current converter 202 with filter/feedback currents converted by voltage-to-current converters 212a-m from voltage signals/values multiplied by these filter/feedback coefficients (k0 . . . kn) 211a-m. The summed current is then passed through integrator 206, where the current is integrated, and then the integrated current is passed through current-to-voltage converter 210, which converts the resulting integrated current back to a voltage.

The resulting voltage value is then provided across a peak detector 209 (or some other amplitude measurement means) as well as sample and delay latch (sampling latch) 207 series-connected to a sequence of delay elements/stages (z⁻¹) 113a-n (where n is illustrated as being m−1). Peak detector 209 is connected to the output 215 (i.e., to the CDR loop) of the DFE system. In the illustrative embodiment, the value of the output 215 is maximized by/in the CDR loop for optimum phase setting by adjusting the sampling clock phase. Also, the value of the voltage provided across the peak detector 209 contains information about the equalization quantity and may be utilized for optimization of the filter coefficients.

Sampling latch 207 is utilized to make a bit decision based on the resulting input voltage (from current-to-voltage converter 210). After sampling the input, the result is provided as data output 217, which is tapped at a node between the output of sampling latch 207 and the first delay element 113a of the sequence of series-connected delay elements/stages (z⁻¹) 113a-n. Also, once sampling is completed, the integrator 206 is reset before analysis of the next bit. The delay stages 113a-n collectively store a number of previously-detected bits generated from the sampling latch 207. Each of sampling latch 207 and delay elements/stages 113a-n receive an input of the data clock 208 to enable synchronized operation of the enhanced DFE circuit. As described above, these delay stages 113a-n are connected to corresponding weighted voltage coefficients 211a-m, which are in turn connected to current feedback converters 212a-m.

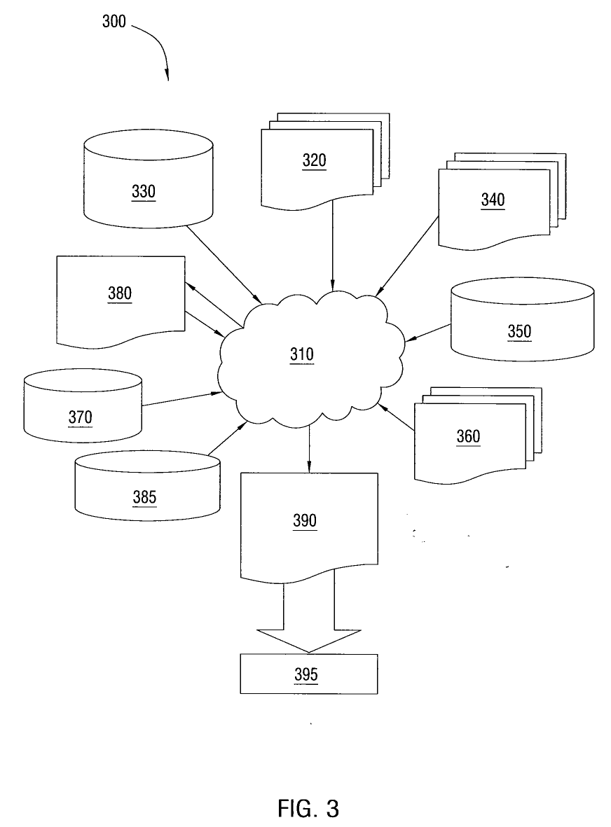

FIG. 3 shows a block diagram of an exemplary design flow 300 used for example, in semiconductor design, manufacturing, and/or test. Design flow 300 may vary depending on the type of IC being designed. For example, a design flow 300 for building an application specific IC (ASIC) may differ from a design flow 300 for designing a standard component. Design structure 320 is preferably an input to a design process 310 and may come from an IP provider, a core developer, or other design company or may be generated by the operator of the design flow, or from other sources. Design structure 320 comprises the circuit described above and shown in FIG. 2 in the form of schematics or HDL, a hardware-description language (e.g., Verilog, VHDL, C, etc.). Design structure 320 may be contained on one or more machine readable medium. For example, design structure 320 may be a text file or a graphical representation of a circuit as described above and shown in FIG. 2. Design process 310 preferably synthesizes (or translates) the circuit described above and shown in FIG. 2 into a netlist 380, where netlist 380 is, for example, a list of wires, transistors, logic gates, control circuits, I/O, models, etc. that describes the connections to other elements and circuits in an integrated circuit design and recorded on at least one of machine readable medium. For example, the medium may be a storage medium such as a CD, a compact flash, other flash memory, or a hard-disk drive. The medium may also be a packet of data to be sent via the Internet, or other networking suitable means. The synthesis may be an iterative process in which netlist 380 is resynthesized one or more times depending on design specifications and parameters for the circuit.

Design process 310 may include using a variety of inputs; for example, inputs from library elements 330 which may house a set of commonly used elements, circuits, and devices, including models, layouts, and symbolic representations, for a given manufacturing technology (e.g., different technology nodes, 32 nm, 45 nm, 90 nm, etc.), design specifications 340, characterization data 350, verification data 360, design rules 370, and test data files 385 (which may include test patterns and other testing information). Design process 310 may further include, for example, standard circuit design processes such as timing analysis, verification, design rule checking, place and route operations, etc. One of ordinary skill in the art of integrated circuit design can appreciate the extent of possible electronic design automation tools and applications used in design process 310 without deviating from the scope and spirit of the invention. The design structure of the invention is not limited to any specific design flow.

Design process 310 preferably translates a circuit as described above and shown in FIG. 2, along with any additional integrated circuit design or data (if applicable), into a second design structure 390. Design structure 390 resides on a storage medium in a data format used for the exchange of layout data of integrated circuits (e.g. information stored in a GDSII (GDS2), GL1, OASIS, or any other suitable format for storing such design structures). Design structure 390 may comprise information such as, for example, test data files, design content files, manufacturing data, layout parameters, wires, levels of metal, vias, shapes, data for routing through the manufacturing line, and any other data required by a semiconductor manufacturer to produce a circuit as described above and shown in FIG. 2. Design structure 390 may then proceed to a stage 395 where, for example, design structure 390: proceeds to tape-out, is released to manufacturing, is released to a mask house, is sent to another design house, is sent back to the customer, etc.

With the above circuit configuration, the coefficients of the DFE feedback paths may be determined using a method by which the variations of the integrated summing currents are minimized. With this implementation, the level of system equalization is directly correlated to the inverse size of the variations in the summed and integrated currents. That is the better the system is equalized, the smaller the variations in the summed and integrated currents will be. In another embodiment, the coefficients are determined by applying conventional algorithms known from literature.

The above described embodiment provides an integration solution based on one-sample-per-bit integration including an additional current that may depend on any number of prior bits. Unlike conventional integration in which a very small value may frequently be obtained if the timing is wrong, the present embodiment provides the necessary amplification by maximizing the sensitivity of the data latch. This process of maximizing the sensitivity is achieved using the integration function in front of the data latch. The invention thus performs an eye centering algorithm by utilizing the fact that the peak is at its maximum while the phase error is minimum.

In one alternative embodiment, the integration of the DFE feedback currents may be completed in a second integrator and results of the integration of the data-dependent currents and the currents from the feedback paths may be applied to the even and odd inputs of a different decision circuit. This embodiment is of special interest when competing single ended data transmission.

Among the advantages provided, one key advantage is power savings, which result from the number of samples per bit (i.e., one), which is half the usual value of two samples per bit. Given that DFE receiver power may be 20% or more of total link power, this power savings is a substantial advantage. Additionally, a smaller circuit and smaller area is required for the DFE circuit, leading to savings in circuit area on the receiver, which in turn provides improved cost-savings for cost-sensitive applications.

As a final matter, it is important that while an illustrative embodiment of the present invention has been, and will continue to be, described in the context of a fully functional computer system with installed management software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as floppy disks, hard disk drives, CD ROMs, and transmission type media such as digital and analogue communication links.

While the invention has been particularly shown and described with reference to a preferred embodiment, it will be understood by those skilled in the art that various changes in form and detail may be made therein without departing from the spirit and scope of the invention.

What is claimed is:

1. A design structure embodied in a machine readable storage medium for at least one of designing, manufacturing, and testing a design, the design structure comprising:
a receiver circuit comprising:
a decision feedback equalizer (DFE) that produces one sample per bit; and
means for automatically self-adjusting the DFE to enable an eye centering process by which peak energy is maintained within the receiver circuit when phase error is a minimum.

2. The design structure of claim 1, further comprising a clock and data recovery circuitry with peak detector functionality, which provides phase loop detection for a received signal and which utilizes one sample per bit.

3. The design structure of claim 1, further comprising:
means for converting a received voltage signal into a current; and
means for summing the current with one or more feedback currents derived from previously received signals to generated a summed current signal.

4. The design structure of claim 3, further comprising:
a delay stage within which is passed one or more previously-detected bits, said delay stage comprising serially-connected delay components, each coupled to the means for summing the current via respective pre-determined programmable feedback coefficients and voltage-to-current converters;
wherein said feedback currents comprise weighted currents determined by voltage values of the previously detected bits multiplied by respective pre-determined and programmable feedback coefficients and converted into respective ones of the weighted currents via the voltage-to-current converters.

5. The design structure of claim 3, further comprising:
means for integrating the summed current signal to (1) maximize the energy of the summing node, which energy is utilize to switch a sampling latch and (2) maximize the sensitivity of the sampling latch, wherein the means for integrating produces an integrated current output; and
means for converting the output of the integrating means from an integrated current to a resulting voltage.

6. The design structure of claim 5, further comprising:
sampling means for generating a single bit sample from the resulting voltage, said sampling means associated with the data latch.

7. The design structure of claim 6, further comprising means for resetting the integrator after the sampling of the resulting voltage before a next analysis is performed.

8. The design structure of claim 5, further comprising a peak detector coupled to an output of the means for integrating and which measures an amplitude of the integrated current output, which output is forwarded to a CDR loop and maximized for optimum phase setting within the CDR loop by adjusting a sampling clock phase.

9. The design structure of claim 1, further comprising a data output, which is provided at a node between the sampling means and a first delay element of the delay stage.

10. The design structure of claim 7, further comprising a data clock input, which provides clock signals for each of the means for integrating, the means for sampling and the delay elements within the delay stage with a clock input.

11. The design structure of claim 1, wherein the design structure comprises a netlist, which describes the receiver circuit.

12. The design structure of claim 1, wherein the design structure resides on the machine readable storage medium as a data format used for the exchange of layout data of integrated circuits.
